(19) United States
(12) Patent Application Publication
(10) Pub. No.: US 2024/0340702 A1
(43) Pub. Date: Oct. 10, 2024

(54) METHOD FOR RESOURCE INDICATION, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Yi ZHANG, Dongguan (CN); Jing XU, Dongguan (CN); Bin LIANG, Dongguan (CN); Yanan LIN, Dongguan (CN)

(21) Appl. No.: 18/748,835

(22) Filed: Jun. 20, 2024

Related U.S. Application Data
(63) Continuation of application No. PCT/CN2021/143747, filed on Dec. 31, 2021.

(51) Int. Cl. H04W 28/12; H04L 5/00; H04W 72/23

(52) U.S. Cl. CPC H04W 28/12; H04L 5/0048; H04W 72/23

(57) ABSTRACT

A method for resource indication and a terminal device are provided. The method includes the following. A terminal device receives downlink control information (DCI) sent by a network device. The DCI is used for scheduling P channels, and the P channels are located on at most N serving cells and/or serving cell groups, where P and N each are a positive integer, and N≤P. The DCI includes a resource assignment field, and the resource assignment field indicates resources for the P channels.

### CROSS-REFERENCE TO RELATED APPLICATION(S)

This application is a continuation of International Application No. PCT/CN2021/143747, filed Dec. 31, 2021, the entire disclosure of which is incorporated herein by reference.

### TECHNICAL FIELD

This disclosure relates to the field of communication technology, and more particularly, to the technical field of resource indication.

### BACKGROUND

In a new radio (NR) radio access system, uplink transmission and downlink transmission each support two frequency domain resource allocation types: frequency domain resource allocation type 0 and frequency domain resource allocation type 1. A network side configures, via a higher layer parameter (for example, resourceAllocation), a frequency domain resource allocation type used by a terminal device, for example, frequency domain resource allocation type 0, frequency domain resource allocation type 1, or dynamic switch (namely, the parameter is set to dynamicswitch). If dynamic switch is configured, the network side indicates the frequency domain resource allocation type used by the terminal device via a frequency domain resource assignment (FDRA) field in downlink control information (DCI).

If a bandwidth part (BWP) indicator field is not configured in scheduling DCI or the terminal device does not support BWP change via DCI, resource block (RB) indexing for the frequency domain resource allocation type is determined within an active BWP of the terminal device. If the terminal device supports BWP change via DCI and the BWP indicator field is configured in the scheduling DCI, RB indexing for the frequency resource allocation type is determined within a BWP indicated by the BWP indicator field in the DCI. Therefore, the terminal device needs to firstly determine a BWP after a physical downlink control channel (PDCCH) is detected and then determine frequency domain resource allocation within the BWP.

An NR system supports the terminal device to perform PDCCH blind detection in a search space set (SSS) configured by the network side. The reason for which it is called “blind detection” is that the terminal device does not know information such as DCI format before DCI carried on a PDCCH is detected. Therefore, the terminal device needs to use some fixed DCI sizes to perform blind detection of candidate PDCCHs in an SSS. In order to reduce complexity of PDCCH blind detection of the terminal device, it is specified in NR that after a DCI size alignment procedure defined in a protocol is completed, the terminal device does not expect that a total DCI size is greater than 4, and a total DCI size scrambled by a cell-radio network temporary identifier (C-RNTI) is greater than 3.

Since the terminal device only attempts to use some fixed DCI sizes to perform PDCCH detection, the terminal device needs to know DCI sizes of different DCI formats before PDCCH blind detection. That is, before PDCCH blind detection, the terminal device needs to know the number of bits in each information field, such as an FDRA field, in DCI. In addition, how to realize resource indication by using a bit(s) in an indicator field is a problem to be solved.

### SUMMARY

A method for resource indication is provided. The method includes the following. A terminal device receives downlink control information (DCI) sent by a network device. The DCI is used for scheduling P channels, and the P channels are located on at most N serving cells and/or serving cell groups, where P and N each are a positive integer and N≤P. The DCI includes a resource assignment field, and the resource assignment field indicates resources for the P channels.

A network device is provided. The network device includes a transceiver, a processor and a memory. The processor is configured to cause the transceiver to send DCI to a terminal device. The DCI is used for scheduling P channels, and the P channels are located on at most N serving cells and/or serving cell groups, where P and N each are a positive integer and N≤P. The DCI includes a resource assignment field, and the resource assignment field indicates resources for the P channels.

A terminal device is provided. The terminal device includes a transceiver, a processor and a memory. The processor is configured to invoke programs in the memory to perform any implementation of the method for resource indication applied to the terminal device in the disclosure.

### BRIEF DESCRIPTION OF THE DRAWINGS

FIG. 1 is an architectural diagram of a system to which implementations of the disclosure are applied.

FIG. 2 is a flowchart of a method for resource indication provided in implementation I of the disclosure.

FIG. 3 is a schematic diagram illustrating a scheduled serving cell(s) and/or serving cell group(s) according to implementation I of the disclosure.

FIG. 4 is a schematic block diagram of a terminal device provided in implementation II of the disclosure.

FIG. 5 is a schematic block diagram of a network device provided in implementation III of the disclosure.

FIG. 6 is a schematic structural diagram of a device provided in implementation IV of the disclosure.

### DETAILED DESCRIPTION

To make objectives, technical solutions, and advantages of the disclosure clearer, the following will describe the disclosure in further detail with reference to the accompanying drawings and implementations. It should be understood that, the implementations described herein are only intended to explain the disclosure rather than limit the disclosure. The disclosure may, however, be implemented in many different forms and is not limited to the implementations described herein. Instead, these implementations are provided so that the disclosure will be thorough and complete.

Unless otherwise defined, all technical and scientific terms used herein have the same meaning as those commonly understood by those of ordinary skill in the art related to the disclosure. The terms used herein in the specification of the disclosure is only intended for describing implementations rather than limiting the disclosure.

It should be understood that, the terms “system” and “network” herein are usually used interchangeably throughout this disclosure. The term “and/or” herein only describes an association between associated objects, which means that there may be three relationships. For example, A and/or B can mean A alone, both A and B exist, and B alone. In addition, the character “/” herein generally indicates that the associated objects are in an “or” relationship.

Implementations of the disclosure may be applied to various communication systems, for example, a global system of mobile communication (GSM), a code division multiple access (CDMA) system, a wideband code division multiple access (WCDMA) system, a general packet radio service (GPRS), a long term evolution (LTE) system, an advanced LTE (LTE-A) system, a new radio (NR) system, an evolved system of an NR system, an LTE-based access to unlicensed spectrum (LTE-U) system, an NR-based access to unlicensed spectrum (NR-U) system, a universal mobile telecommunication system (UMTS), a wireless local area network (WLAN), a wireless fidelity (WiFi), a next-generation communication system, or other communication systems, etc.

Generally speaking, a conventional communication system generally supports a limited quantity of connections and therefore is easy to implement. However, with development of communication technology, a mobile communication system will not only support conventional communication but also support, for example, device to device (D2D) communication, machine to machine (M2M) communication, machine type communication (MTC), or vehicle to vehicle (V2V) communication, etc. Implementations of the disclosure can also be applied to these communication systems.

The communication system in implementations of the disclosure may be applied to a carrier aggregation (CA) scenario, a dual connectivity (DC) scenario, or a standalone (SA) network deployment scenario.

There is no limitation on the spectrum to which implementations of the disclosure are applied. For example, implementations of the disclosure may be applied to a licensed spectrum, or may also be applied to an unlicensed spectrum.

In implementations of the disclosure, “serving cell” and “carrier” have the same concept, and may be used interchangeably.

In implementations of the disclosure, “cell group” is not limited to a master cell group (MCG) and a secondary cell group (SCG) in NR, and may refer to a cell group including at least one serving cell in a broad sense.

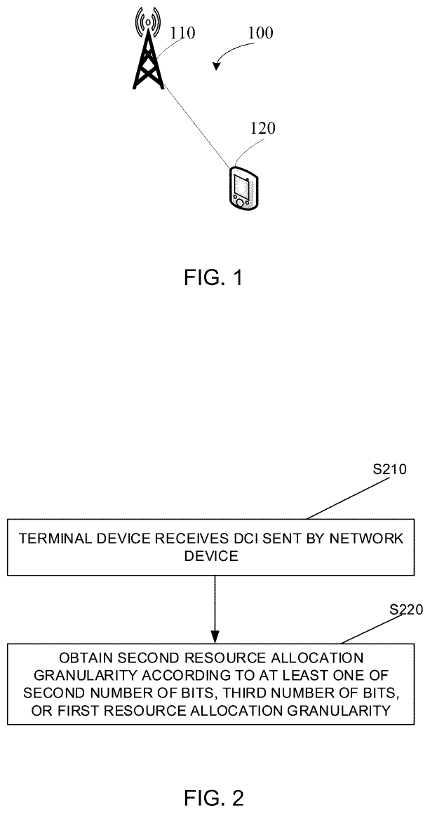

Referring to FIG. 1, FIG. 1 illustrates a wireless communication system 100 to which implementations of the disclosure are applied. The wireless communication system 100 includes a network device 110 and at least one terminal device 120 located within a coverage area of the network device 110. The network device 110 sends trigger signaling or downlink control information (DCI) to the terminal device 120, and the terminal device 120 sends acknowledgement (ACK)/negative ACK (NACK) feedback information to the network device according to the trigger signaling or the DCI.

The wireless communication system 100 may include multiple network devices, and there may be other quantities of terminal devices in a coverage area of each of the network devices. Implementation of the disclosure are not limited in this regard.

The network device 110 may provide communication coverage for a specific geographic region, and may communicate with terminal devices (such as user equipments (UEs)) located within the coverage area. The network device 100 may be a base transceiver station (BTS) in a GSM or a CDMA system, or may be a NodeB (NB) in a WCDMA system, or may be an evolutional Node B (eNB or eNodeB) in an LTE system, or a radio controller in a cloud radio access network (CRAN); or the network device may be a relay station, an access point, an in-vehicle device, a wearable device, a network-side device in a 5^{th}-generation (5G) network, or a network device in a future evolved public land mobile network (PLMN), etc.

The terminal device 120 may be mobile or fixed. The terminal device 120 may refer to an access terminal, a UE, a subscriber unit, a subscriber station, a mobile station, a remote station, a remote terminal, a mobile device, a UE, a terminal, a wireless communication device, a user agent, or a user device. The access terminal may be a cellular radio telephone, a cordless telephone, a session initiation protocol (SIP) telephone, a wireless local loop (WLL) station, a personal digital assistant (PDA), or a device with wireless communication functions such as a handheld device, a computing device, other processing devices coupled with a wireless modem, an in-vehicle device, a wearable device, a terminal device in a 5G network, a terminal device in a future evolved PLMN, etc.

The following implementations of the disclosure will describe in detail how a terminal device determines a resource(s) for a channel(s) on one or more serving cells and/or serving cell groups during scheduling of the channel by DCI, especially for the case where channels on multiple serving cells and/or serving cell groups are scheduled by single DCI. The number of the multiple serving cells and/or serving cell groups scheduled is not fixed, and a size of an active bandwidth part (BWP) (namely, the number of physical resource blocks (PRBs) in the active BWP) or a size of an active BWP set of each serving cell is different. Therefore, for scheduling of channels on multiple serving cells and/or serving cell groups by single DCI, how to determine or use a resource assignment field (including a frequency domain resource assignment (FDRA) field and a time domain resource assignment (TDRA) field) in DCI is a problem to be solved.

In the following implementations of the disclosure, an FDRA field in DCI is taken as an example to elaborate how the terminal device determines a size of an FDRA field in DCI for the case where multiple serving cells and/or serving cell groups are scheduled by single DCI. However, the method and device in the disclosure are not limited to determining the size of an FDRA field, and may also be applied to an indicator field related to BWP size or higher layer configuration parameter, such as a TDRA field, in DCI.

It should be noted that, in frequency domain resource allocation type 0 supported by NR, a resource allocation granularity is RB group (RBG), where the RBG is a set of consecutive virtual RBs, and the number of virtual RBs in each RBG is determined according to a BWP size and a radio resource control (RRC) configuration parameter rbg-Size. In resource allocation type 1 supported by NR, a set of contiguously allocated virtual RBs may be indicated to the terminal, and a starting RB (RBstart) allocated and the number of RBs (LRBs) allocated may be jointly encoded by using a resource indication value (RIV).

When performing physical downlink control channel (PDCCH) blind detection, the terminal device needs to know the number of bits in each information field in DCI. Taking an FDRA field as an example, a scheme for determining the number of bits thereof is as follows.

If only frequency domain resource allocation type 0 is configured, the indicator field has N_{RBG} bits, where N_{RBG} is the total number of RBGs in a BWP. N_{RB}^{DL,BWP} is the number of RBs in an active BWP. In this formula, an active downlink BWP is taken as an example for illustration, and understandably, the formula may also be applied to the number of RBs in an active uplink BWP.

If only frequency domain resource allocation type 1 is configured, the indicator field has ┌log₂(N_{RB}^{DL,BWP}(N_{RB}^{DL,BWP}+1)/2)┐ bits.

If both type 0 and type 1 are configured, the indicator field has max(┌log₂(N_{RB}^{DL,BWP}(N_{RB}^{DL,BWP}+1)/2)┐, N_{RBG})+1 bits. The highest-order bit thereof indicates a resource allocation type used by the terminal, where “0” indicates type 0, and “1” indicates type 1.

### Implementation 1

Referring to FIG. 2, FIG. 2 illustrates a method for resource indication provided in implementation I of the disclosure. The method includes the following.

Step S210, a terminal device receives DCI sent by a network device. The DCI is used for scheduling P channels, and the P channels are located on at most N serving cells and/or serving cell groups, where P and Neach are a positive integer, and N≤P. The DCI includes a resource assignment field, and the resource assignment field indicates resources for the P channels.

In an implementation, N may be a positive integer and N≥2, i. e., the DCI is used for scheduling multiple serving cells and/or serving cell groups.

In an implementation, according to implementations of the disclosure, Q channels in the P channels may be located on the same serving cell or serving cell group, where Q is a positive integer.

In implementations of the disclosure, the resource includes a transmission resource, and the transmission resources includes a time domain transmission resource and/or a frequency domain transmission resource. The resource assignment field includes an FDRA field and/or a TDRA field. The channel includes a physical downlink shared channel (PDSCH) and/or a physical uplink shared channel (PUSCH). In the following implementations of the disclosure, the transmission resource is taken as an example for illustration, and the transmission resource may be replaced by “resource”.

If channels on multiple serving cells and/or serving cell groups are scheduled by single DCI, the DCI needs to include resource allocation indications for multiple channels. Taking an FDRA field as an example, for the case where the DCI includes resource allocation indications for multiple channels, there may be two indication modes: indication mode I, in which multiple channels each correspond to a separate indicator field; and indication mode II, in which multiple channels share the same indicator field. If indication mode I is adopted, it is conducive to flexibility in resource allocation and high spectral efficiency. However, since the number of bits required for an FDRA field is multiplied due to separate indicator fields, DCI overhead will be relatively high, and reliability of a PDCCH will be degraded. If indication mode Il is adopted, DCI overhead can be reduced, but flexibility in resource allocation is low, especially for inter-band carrier aggregation (CA), where a channel on each carrier is not associated with each other. If the same FDRA field is shared, spectral efficiency will be degraded.

Indication mode I: multiple channels each correspond to a separate indicator field to indicate the resources for the P channels respectively.

In implementations of the disclosure, the resource assignment field includes N sub-fields, where the N sub-fields indicate the resources for the P channels. Indication mode I may be applied to the case where a BWP indicator field is configured in the DCI and the terminal device supports active BWP change via the DCI, or may be applied to other cases.

In an implementation, the resource assignment field configured for the terminal device by the network device via higher layer signaling or specified in a protocol includes N sub-fields, for example, a first sub-field, a second sub-field, . . . , and an N^{th} sub-field, where the number of bits in each of the N sub-fields is configured by the network device via higher layer signaling or specified in a protocol. The higher layer signaling may include RRC signaling, media access control (MAC) signaling, a system information block (SIB), and other signaling.

In an implementation, the number of bits in any one of the N sub-fields is configured by a network or specified a protocol.

The N sub-fields may correspond to N serving cells and/or serving cell groups respectively. Alternatively, the N sub-fields may correspond to M serving cells and/or serving cell groups respectively, where M is a positive integer and M<N. That is, the P channels are located on the M serving cells and/or serving cell groups, and accordingly, channels on the M serving cells and/or serving cell groups correspond to M consecutive sub-fields in the N sub-fields in a predefined order. For example, the M sub-fields may be the first M consecutive sub-fields in the N sub-fields, or may be the last M consecutive sub-fields in the N sub-fields. In an implementation, the number of bits in each of the rest of the N sub-fields is set to a predefined value. In other words, if the number of serving cells and/or serving cell groups on which the P channels are located is M and M<N, channels on the M serving cells and/or serving cell groups correspond to M consecutive sub-fields in the N sub-fields in a predefined order, and the number of bits in a sub-field other than the M sub-fields in the N sub-fields is a predefined value.

In an implementation, the predefined order refers to an order in which the serving cells and/or the serving cell groups are scheduled, or an order in which the serving cells and/or the serving cell groups correspond to the N sub-fields. The predefined order may be configured by the network or specified in a protocol, where configuration by the network may include indication by the DCI. The N serving cells and/or serving cell groups or the M serving cells and/or serving cell groups described above may correspond to the N sub-fields in an order that is specified in at least one of mode 1, mode 2, or mode 3 below.

Mode 1: the order is based on the number of bits required for resource allocation.

The number of bits required for channel resource allocation for a serving cell and/or serving cell group described in implementations of the disclosure refers to the number of bits in an indicator field required for resource indication for a channel on the serving cell and/or serving cell group. The number of bits required for channel resource allocation for a serving cell and/or serving cell group may also be referred to as the number of bits required for resource allocation for a channel on the serving cell and/or serving cell group.

The N sub-fields are set in the order of the number of bits, and accordingly, the terminal device expects that serving cells and/or serving cell groups corresponding thereto are scheduled by the N sub-fields in an order of the number of bits required for channel resource allocation for the serving cells and/or serving cell groups, in other words, the terminal device does not expect that the serving cells and/or serving cell groups corresponding thereto are not scheduled in an order of the number of bits required for channel resource allocation for the serving cells and/or serving cell groups. That is, a serving cell and/or serving cell group which requires the maximum number of bits for channel resource allocation is scheduled by a sub-field with the maximum number of bits, while a serving cell and/or serving cell group which requires the minimum number of bits for channel resource allocation is scheduled by a sub-field with the minimum number of bits.

Specifically, if the N sub-fields are set in a descending order of the number of bits, the terminal device expects that the serving cells and/or serving cell groups corresponding thereto are also scheduled by the N sub-fields in a descending order of the number of bits required for channel resource allocation for the serving cells and/or serving cell groups. That is, the terminal device does not expect that the number of bits required for channel resource allocation for an X^{th} serving cell and/or serving cell group is less than the number of bits required for channel resource allocation for an (X+1)^{th} serving cell and/or serving cell group, where X is a positive integer and 1≤X<N. In other words, the terminal device expects that the number of bits required for channel resource allocation for an X^{th} serving cell and/or serving cell group is greater than or equal to the number of bits required for channel resource allocation for an (X+1)^{th} serving cell and/or serving cell group.

Alternatively, the N sub-fields are set in an ascending order of the number of bits, and accordingly, the serving cells and/or serving cell groups corresponding thereto are scheduled by the N sub-fields in an ascending order of the number of bits required for channel resource allocation for the serving cells and/or serving cell groups. That is, the terminal device does not expect that the number of bits required for channel resource allocation for an X^{th} serving cell and/or serving cell group is greater than the number of bits required for channel resource allocation for an (X+1)^{th} serving cell and/or serving cell group, where X is a positive integer and 1≤X<N. In other words, the terminal device expects that the number of bits required for channel resource allocation for an X^{th} serving cell and/or serving cell group is less than or equal to the number of bits required for channel resource allocation for an (X+1)^{th} serving cell and/or serving cell group.

An order between serving cells and/or serving cell groups may be any one of the following: the X^{th} serving cell and then the (X+1)^{th} serving cell; the X^{th} serving cell and then the (X+1)^{th} serving cell group; the X^{th} serving cell group and then the (X+1)^{th} serving cell; or the X^{th} serving cell group and then the (X+1)^{th} serving cell group.

In another working mode of mode 1, there is no limitation on the order in which channels on serving cells and/or serving cell groups are scheduled by a network side, that is, the network side may schedule the channels on the serving cells/serving cell groups in any order, and the terminal establishes a correspondence between the channels on the serving cells/serving cell groups and the N sub-fields according to the number of bits required for channel resource allocation for the serving cells/serving cell groups.

With mode 1, it is conducive to flexibility and high utilization of DCI bits.

Mode 2: the order is based on serving cell index and/or serving cell group index.

Channels on the N serving cells and/or serving cell groups may also correspond to the N sub-fields in the resource assignment field in an order of indexes of the N serving cells and/or serving cell groups, where the order of indexes of the N serving cells and/or serving cell groups includes an ascending order or a descending order.

In an implementation, if in mode 1, the number of bits required for channel resource allocation for each of R serving cells and/or serving cell groups in the N serving cells and/or serving cell groups is the same, the R serving cells and/or serving cell groups correspond to R sub-fields in the resource assignment field in the order of index of serving cell and/or serving cell group.

The R serving cells and/or serving cell groups may include R serving cells, and in this case, the R serving cells are set in an order of serving cell index. Alternatively, the R serving cells and/or serving cell groups may include R serving cell groups, and in this case, the R serving cell groups are set in an order of serving cell group index. Alternatively, the R serving cells and/or serving cell groups may include both serving cell(s) and serving cell group(s) that add up to R, and in this case, the R serving cell(s) and serving cell group(s) are set in an order of serving cell index and serving cell group index.

Mode 3: the order is determined according to an indication of the DCI.

Channels on the N serving cells and/or serving cell groups correspond to the N sub-fields in the resource assignment field respectively in the order indicated by the DCI.

If mode 2 or mode 3 is adopted, it is simple in implementation, but utilization of FDRA bits cannot be maximized.

In an implementation, mode 1, mode 2, and mode 3 described above may be combined with each other. For example, when the channels on the N serving cells and/or serving cell groups correspond to the N sub-fields in the order of the number of bits required for channel resource allocation, if there are at least two serving cells and/or serving cell groups that require the same number of bits for channel resource allocation, the at least two serving cells and/or serving cell groups correspond to sub-fields in the resource assignment field in the order of serving cell index and/or serving cell group index.

With indication mode I, the number of bits in the resource assignment field corresponding to each scheduled serving cell and/or serving cell group is configured by the network device or predefined in a protocol, so that FDRA bits can be less vulnerable to DCI miss detection. That is, the scheme can be better applied in BWP switching (BWP switching may be indicated by DCI). If the terminal device misses DCI used for triggering BWP switching in one of the scheduled serving cells and/or serving cell groups, parsing of FDRAs corresponding to channels on other serving cells and/or serving cell groups will not be affected.

The following is an example of indication mode I.

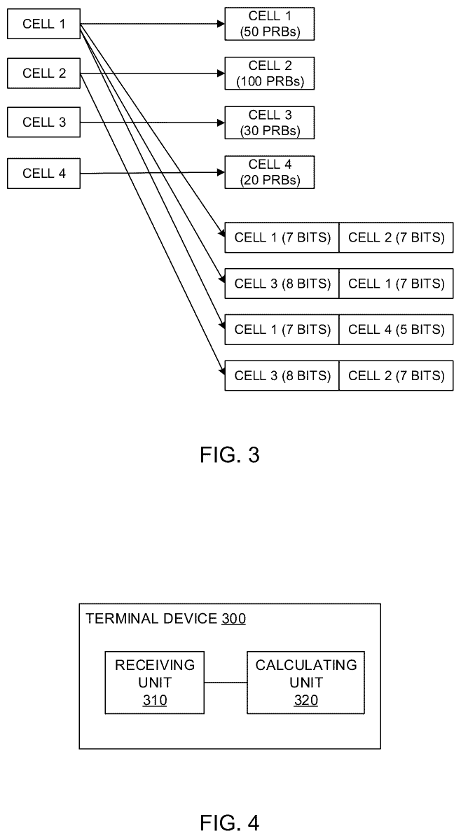

As illustrated in FIG. 3, the network device configures 4 serving cells (cell 1˜cell 4) for the terminal device via higher layer signaling, and a scheduling relationship between the serving cells configured for the terminal device via higher layer signaling is that as illustrated in FIG. 3: cell 1 and cell 2 can be scheduled together as a cell group, cell 1 and cell 3 can be scheduled together as a cell group, and cell 1 and cell 4 can be scheduled together as a cell group; and cell 3 and cell 2 can be scheduled together as a cell group. The number of PRBs illustrated in FIG. 3 is the number of PRBs in an active BWP of each cell (numbered starting from RB=0). Frequency domain resource allocation type 0 is configured to be used for each of cell 1˜cell 4, and a resource scheduling granularity, namely an RBG size (RRC configuration parameter RBG-Size), is configured as configuration 2. Accordingly, a resource scheduling granularity, namely an RBG size, for each of cell 1˜cell 4 is 8 RPBs, 16 PRBs, 4 PRBs, and 4 PRBs respectively, that is, the number of bits required for scheduling each of cell 1˜cell 4 is

$$⌈ \frac{50}{8} ⌉ = 7 , ⌈ \frac{100}{16} ⌉ = 7 , ⌈ \frac{30}{4} ⌉ = 8 , and ⌈ \frac{20}{4} ⌉ = 5$$

respectively.

The resource assignment field configured for the terminal by the network side via higher layer signaling or specified in a protocol includes N=2 sub-fields, for example, a first sub-field has 8 bits, and a second sub-field has 5 bits, i. e. the number of bits in the first sub-field is greater than the number of bits in the second sub-field.

If the last combination illustrated in FIG. 3, namely cell 3+cell 2, is scheduled by the DCI, according to mode 1 described above, the terminal device does not expect that in the combination of cell 2+cell 3 scheduled by the DCI, cell 2 corresponds to the first sub-field while cell 3 corresponds to the second sub-field. The reason is that the number of bits required for cell 2 is less than the number of bits required for cell 3, and as a result, utilization of DCI bits is degraded. In other words, if it is specified that a 1^{st} cell scheduled by the network side corresponds to the first sub-field and a 2^{nd} cell scheduled by the network side corresponds to the second sub-field, the terminal device does not expect that the 1^{st} cell scheduled by the network side is cell 2 and the 2^{nd} cell scheduled by the network side is cell 3, while the terminal device expects that the 1^{st} cell scheduled by the network side is cell 3 and the 2^{nd} cell scheduled by the network side is cell 2. That is, cell 2 and cell 3 correspond to the two sub-fields in a descending order of the number of FDRA bits required for scheduling a channel on each of cell 2 and cell 3. The number of bits required for scheduling cell 3 is 8, and the number of bits required for scheduling cell 2 is 7. Accordingly, cell 3 corresponds to the first sub-field, and cell 2 corresponds to the second sub-field.

In another working mode of mode 1, there is no limitation on the order in which channels on serving cells are scheduled by the network side, that is, the network side may schedule the channels on the serving cells in any order, and the terminal establishes a correspondence between the channels on the serving cells and the N sub-fields according to the number of bits required for channel resource allocation for the serving cells.

If any of the first four combinations in FIG. 3 (namely, a single cell) is scheduled by the DCI, according to indication mode I described above, a channel on the scheduled cell may correspond to the first sub-field, and a bit(s) in the second sub-field is set to a predefined value, for example, all 0.

Referring to FIG. 3 again, an example of scheduling a cell group is as follows: cell 1 and cell 2 belong to cell group 1, and cell 3 and cell 4 belong to cell group 2. The number of bits required for channel resource allocation for cell group 1 is

$$max \{ ⌈ \frac{50}{8} ⌉ = 7 , ⌈ \frac{100}{16} ⌉ = 7 \} = 7 or AND \{ ⌈ \frac{50}{8} ⌉ = 7 , ⌈ \frac{100}{16} ⌉ = 7 \} = 14 , and “ 7 ”$$

will be taken as an example for illustration below. Similarly, the number of bits required for channel resource allocation for cell group 2 is 8 or 13, and “8” will be taken as an example for illustration below.

The resource assignment field configured for the terminal by the network side via higher layer signaling or specified in a protocol includes N=2 sub-fields, for example, a first sub-field has 8 bits, and a second sub-field has 5 bits, i. e. the number of bits in the first sub-field is greater than the number of bits in the second sub-field.

If the last combination illustrated in FIG. 3, namely cell 3+cell 2, is scheduled by the DCI, according to mode 1 described above, the terminal device does not expect that cell group 1 (including cell 2) scheduled by the DCI corresponds to the first sub-field while cell group 2 (including cell 3) corresponds to the second sub-field. The reason is that the number of bits required for cell group 1 is less than the number of bits required for cell group 2, and as a result, utilization of DCI bits is degraded. In other words, if it is specified that a 1^{st} cell group scheduled by the network side corresponds to the first sub-field and a 2^{nd} cell group scheduled by the network side corresponds to the second sub-field, the terminal does not expect that the 1^{st} cell group scheduled by the network side is cell group 1 and the 2^{nd} cell group scheduled by the network side is cell group 2, while the terminal expects that the 1^{st} cell group scheduled by the network side is cell group 2 and the 2^{nd} cell group scheduled by the network side is cell group 1. That is, the cell groups scheduled correspond to the two sub-fields in a descending order of the number of FDRA bits required for each of the cell groups. The number of bits required for scheduling cell group 2 is 8, and the number of bits required for scheduling cell group 1 is 7. Accordingly, cell group 2 corresponds to the first sub-field, and cell group 1 corresponds to the second sub-field.

In another working mode of mode 1, there is no limitation on the order in which channels on serving cell groups are scheduled by the network side, that is, the network side may schedule the channels on the serving cell groups in any order, and the terminal establishes a correspondence between the channels on the serving cell groups and the N sub-fields according to the number of bits required for channel resource allocation for the serving cell groups.

Indication mode II: one indicator field is shared by multiple channels.

In implementations of the disclosure, the resource assignment field is shared by the P channels. That is, the resource assignment field does not include any sub-field, and bits in the whole resource assignment field indicate the resources for the P channels, without allocating a corresponding sub-field to at least one of the P channels.

In an implementation, the number of bits in the resource assignment field is configured by a network or specified in a protocol.

In an implementation, the resource assignment field may include only one sub-field, and the sub-field indicates the resources for the P channels. That is, the sub-field in the resource assignment field is shared by the P channels. The number of bits in the sub-field is configured by a network or specified in a protocol.

In an implementation, the method further includes the following.

S220, a second resource allocation granularity is obtained according to at least one of a second number of bits, a third number of bits, or a first resource allocation granularity. The second resource allocation granularity is a resource allocation granularity used during current transmission.

The number of bits required for resource allocation for each of the P channels is a first number of bits. The second number of bits is a sum of all the first number of bits, i.e. the total number of bits required for resource allocation for the P channels is the second number of bits. The number of bits in the resource assignment field is the third number of bits.

In an implementation, if Q channels in the P channels are located on the same cell or cell group and Q is a positive integer, S220 further includes the following. A second resource allocation granularity for the Q channels is obtained according to at least one of a fifth number of bits, a sixth number of bits, or a first resource allocation granularity.

The number of bits required for resource allocation for each of the Q channels is a fourth number of bits. The fifth number of bits is a sum of all the fourth number of bits, i.e. the fifth number of bits is a sum of the number of bits required for resource allocation for the Q channels. The sixth number of bits is the number of bits in a sub-field corresponding to the Q channels in the resource assignment field. In an implementation, the first resource allocation granularity or the second resource allocation granularity is one PRB or one group of PRBs, where the group of PRBs include at least two PRBs. Specifically, for frequency domain resource allocation type 0, the resource allocation granularity represents the number of RBs in each group of PRBs such as RBG. However, it should be noted that, the RBG may be determined according to RBG-Size configured per BWP of each cell, and RBG sizes of active BWPs of cells for different PDSCHs may be the same or different. The RBG may also be set to a fixed value or a predefined value for BWPs of all cells. For frequency domain resource allocation type 1, the resource allocation granularity is RB.

Exemplarily, the network side configures frequency domain resource allocation type 0 to be used for all the serving cells and/or serving cell groups.

If the second number of bits is less than or equal to the third number of bits or the fifth number of bits is less than or equal to the sixth number of bits, the second resource allocation granularity is the same as the first resource allocation granularity; or the second resource allocation granularity is determined according to the first resource allocation granularity and a first value; or the second resource allocation granularity is a first candidate value in a first candidate value set, where the first candidate value is a minimum value among candidate values in the first candidate value set that are greater than or equal to a second value.

If the second number of bits is greater than the third number of bits or the fifth number of bits is greater than the sixth number of bits, the second resource allocation granularity is determined according to the first resource allocation granularity and a first value; or the second resource allocation granularity is a second candidate value in a second candidate value set, where the second candidate value is a minimum value among candidate values in the second candidate value set that are greater than or equal to a second value.

In an implementation, the first value is determined according to the second number of bits and the third number of bits, or is determined according to the fifth number of bits and the sixth number of bits. The second value is determined according to the first resource allocation granularity and the first value.

In an implementation, the first value is equal to a ratio of the second number of bits to the third number of bits, or the first value is equal to a ratio of the fifth number of bits to the sixth number of bits.

In an implementation, the second resource allocation granularity is a resource allocation granularity obtained after rounding up, rounding down, or rounding to the nearest integer on a product of the first resource allocation granularity and the first value.

In an implementation, the second value is a value obtained after rounding up, rounding down, or rounding to the nearest integer on a product of the first resource allocation granularity and the first value.

In an implementation, the first candidate value set and the second candidate value set may be the same value set or different value sets.

In an implementation, in indication mode I described above, if Q channels in the P channels are located on the same serving cell or serving cell group, indication mode II may also be applied to resource indication for the Q channels. Alternatively, if the number of bits required for channel resource allocation for a serving cell and/or serving cell group is greater than the number of bits in a corresponding sub-field, indication mode II may also be applied to resource indication for the Q channels. In this case, the Q channels share one corresponding sub-field, where the second number of bits is the total number of bits required for resource allocation for the Q channels, and the third number of bits is the number of bits in the sub-field corresponding to the Q channels in the resource assignment field. Accordingly, the terminal device may obtain the resource allocation granularity for the Q channels according to at least one of the second number of bits, the third number of bits, or the first resource allocation granularity in indication mode II.

With indication mode II, if the total number of bits in an FDRA field or sub-field is less than the number of bits required for channel resource allocation, the first value is a number greater than 1, and the second resource allocation granularity obtained by multiplying the first resource allocation granularity by the first value is greater than the first resource allocation granularity. As such, the number of bits required for channel resource allocation will be reduced due to increase in resource allocation granularity, thereby realizing resource indication by using an FDRA field or sub-field. On the contrary, if the total number of bits in an FDRA field or sub-field is greater than the number of bits required for channel resource allocation, the first value is a number less than 1, and the second resource allocation granularity obtained by multiplying the first resource allocation granularity by the first value is less than the first resource allocation granularity. As such, the number of bits required for channel resource allocation will be increased due to reduction in resource allocation granularity, thereby realizing higher utilization of an FDRA field or sub-field for resource indication. To summarize, in indication mode II, no matter whether the number of scheduled serving cells and/or serving cell groups reaches the maximum value N, the number of bits allocated for an FDRA field can be fully utilized, and the finest resource allocation granularity can be realized as much as possible. However, if the terminal misses a DCI used for triggering BWP switching in one of the scheduled serving cells and/or serving cell groups, parsing of FDRAs corresponding to channels on other serving cells and/or serving cell groups will be affected.

The following is an example of indication mode II.

In this example, the configuration of serving cells by the network device, the scheduling relationship, the resource allocation type, the number of PRBs in an active BWP of each serving cell, the RBG size, and the number of bits required for scheduling of each of cell 1˜cell 4 are consistent with those in the example of indication mode I.

Referring to FIG. 3 again, assume that the network side configures resource allocation type 0 to be used for each of cell 1˜cell 4. The resource assignment field configured for the terminal by the network side via higher layer signaling or specified in a protocol includes 1 sub-field, for example, the first sub-field has 10 bits, that is, the third number of bits is 10 bits. If the last combination illustrated in FIG. 3, namely cell 3+cell 2, is scheduled by the DCI, the number of bits required for scheduling channels on cell 2 and cell 3 is 8+7=15 bits, that is, the second number of bits is 15 bits. Since the second number of bits is greater than the third number of bits, the resource scheduling granularity needs to be scaled as follows:

The resource scheduling granularity for cell 3 is:

$$⌈ RBG size \times \frac{second number of bits}{third number of bits} ⌉ = ⌈ 4 RBs \times \frac{15}{10} ⌉ = 6 RBs ;$$

The resource scheduling granularity for cell 2 is:

$$⌈ RBG size \times \frac{second number of bits}{third number of bits} ⌉ = ⌈ 16 RBs \times \frac{15}{10} ⌉ = 24 RBs .$$

In an implementation, the terminal device can use the adjusted resource scheduling granularities above as the resource scheduling granularity for cell 3 and the resource scheduling granularity for cell 2 respectively.

The terminal device may also select, from a candidate value set configured by a base station or predefined, the minimum value that is greater than the above value as the resource scheduling granularity for cell 2 or cell 3. Assuming that the second candidate value set configured for cell 2 and cell 3 is {1, 2, 4, 8, 16, 32}, the resource scheduling granularity for cell 3 is a second value that is greater than or equal to 6 RBs in the set, and accordingly, the second value is 8 RBs in the candidate value set; similarly, the resource scheduling granularity for cell 2 is a second value that is greater than or equal to 24 RBs and accordingly, the second value is 32 PRBs in the candidate resource set.

Referring to FIG. 3 again, assuming that the network side configures resource allocation type 1 to be used for each of cell 1˜cell 4, the number of bits required for scheduling each of cell 1˜cell 4 is ┌log₂(50(50+1)/2)┐=11 bits, ┌log₂(100(100+1)/2)┐=13 bits, ┌log₂(30(30+1)/2)┐=9 bits, and ┌log₂(20(20+1)/2)┐=8 bits respectively.

The resource assignment field configured for the terminal device by the network device via higher layer signaling or specified in a protocol includes 1 sub-field, for example, the first sub-field has 10 bits, that is, the third number of bits is 10 bits. If the last combination illustrated in FIG. 3, namely cell 3+cell 2, is scheduled by the DCI, the second number of bits is 9+13=22 bits. Since the second number of bits is greater than the third number of bits, the resource scheduling granularity is scaled as follows: the frequency domain allocation granularity for each of cell 3 and cell 2 is

$$⌈ \frac{second number of bits}{third number of bits} ⌉ PRBs = 3 PBRs .$$

In an implementation, in indication mode I and indication mode II described above, channels on the serving cells and/or serving cell groups may also be scheduled in an order indicated by the DCI.

In an implementation, according to implementations of the disclosure, an order in which channels on the serving cells and/or the serving cell groups are scheduled may be at least one of the following orders in which the channels correspond to the N sub-fields: an order of serving cell index and/or serving cell group index, an order determined according to an indication of the DCI, or an order of the number of bits required for channel resource allocation for each serving cell and/or serving cell group.

In implementations of the disclosure, for each scheduling or configuration by the network side, there is no limitation regarding whether all the P channels on the N serving cells and/or serving cell groups are scheduled or configured or only some of the P channels are scheduled or configured.

In implementations of the disclosure, the P channels scheduled may be all PDSCHs, or may be all PUSCHs, or some are PDSCHs and the rest are PUSCHs. If a PDSCH is scheduled, the active BWP refers to an active downlink BWP. If a PUSCH on a cell is scheduled, the active BWP refers to an active uplink BWP.

In embodiments of the disclosure, a resource(s) for a channel(s) located on one or more serving cells and/or serving cell groups is indicated by a resource assignment field in DCI, and as such, a channel(s) on one or more serving cells configured for the terminal device by the network device can be scheduled by single DCI, thereby reducing signaling overhead and improving DCI utilization.

### Implementation 2

Referring to FIG. 4, FIG. 4 is a schematic structural diagram of a terminal device 300 provided in implementation II of the disclosure. The terminal device 300 is configured for resource indication. The terminal device 300 includes a receiving unit 310. The receiving unit 310 is configured to receive DCI sent by a network device. The DCI is used for scheduling P channels, and the P channels are located on at most N serving cells and/or serving cell groups, where P and N each are a positive integer and N≤P. The DCI includes a resource assignment field, and the resource assignment field indicates resources for the P channels.

In an implementation, the resource assignment field includes N sub-fields.

In an implementation, the N sub-fields indicate the resources for the P channels. The N sub-fields are set in a descending order of the number of bits in each sub-field, and the terminal device does not expect that the number of bits required for channel resource allocation for an X^{th} serving cell and/or serving cell group is less than the number of bits required for channel resource allocation for an (X+1)^{th} serving cell and/or serving cell group, where X is a positive integer and 1≤X<N. Alternatively, the N sub-fields are set in an ascending order of the number of bits, and the terminal device does not expect that the number of bits required for channel resource allocation for an X^{th} serving cell and/or serving cell group is greater than the number of bits required for channel resource allocation for an (X+1)^{th} serving cell and/or serving cell group, where X is a positive integer and 1≤X<N.

In an implementation, if the number of bits required for channel resource allocation for each of R serving cells and/or serving cell groups in the N serving cells and/or serving cell groups is the same, the R serving cells and/or serving cell groups correspond to R sub-fields in the resource assignment field in an order of serving cell index and/or serving cell group index.

In an implementation, if the number of serving cells and/or serving cell groups on which the P channels are located is M and M<N, channels on the M serving cells and/or serving cell groups correspond to M consecutive sub-fields in the N sub-fields in a predefined order, and the number of bits in a sub-field other than the M sub-fields in the N sub-fields is a predefined value.

In an implementation, the number of bits in the N sub-fields in the resource assignment field is configured by a network or specified in a protocol.

In an implementation, the resource assignment field is shared by the P channels. The terminal device further includes a calculating unit 320. The calculating unit 320 is configured to obtain a second resource allocation granularity according to at least one of a second number of bits, a third number of bits, or a first resource allocation granularity, where the number of bits required for resource allocation for each of the P channels is a first number of bits, the second number of bits is a sum of all the first number of bits, and the third number of bits is the number of bits in the resource assignment field.

In an implementation, Q channels in the P channels are located on the same serving cell or serving cell group, where Q is a positive integer. The calculating unit 320 is further configured to obtain a second resource allocation granularity for the Q channels according to at least one of a fifth number of bits, a sixth number of bits, or a first resource allocation granularity, where the number of bits required for resource allocation for each of the Q channels is a fourth number of bits, the fifth number of bits is a sum of all the fourth number of bits, and the sixth number of bits is the number of bits in a sub-field corresponding to the Q channels in the resource assignment field.

In an implementation, the second number of bits is less than or equal to the third number of bits, or the fifth number of bits is less than or equal to the sixth number of bits. The calculating unit 320 is further configured to: determine that the second resource allocation granularity is the same as the first resource allocation granularity; or determine the second resource allocation granularity according to the first resource allocation granularity and a first value; or determine that the second resource allocation granularity is a first candidate value in a first candidate value set, where the first candidate value is a minimum value of among candidate values in the first candidate value set that are greater than or equal to a second value.

In an implementation, the second number of bits is greater than the third number of bits, or the fifth number of bits is greater than the sixth number of bits. The calculating unit 320 is further configured to: determine the second resource allocation granularity according to the first resource allocation granularity and a first value; or determine that the second resource allocation granularity is a second candidate value in a second candidate value set, where the second candidate value is a minimum value among candidate values in the second candidate value set that are greater than or equal to a second value.

In an implementation, the calculating unit 320 is further configured to: determine the first value according to the second number of bits and the third number of bits, or determine the first value according to the fifth number of bits and the sixth number of bits; determine the second value according to the first resource allocation granularity and the first value.

In an implementation, the first resource allocation granularity is one PRB or one group of PRBs, where the group of PRBs includes at least two PRBs. However, the first resource allocation granularity is not limited thereto, and may also be other resource granularities, such as a time domain resource granularity.

In an implementation, the number of bits in the sub-field in the resource assignment field is configured by a network or specified in a protocol.

In an implementation, channels on one or more serving cells and/or serving cell groups in the N serving cells and/or serving cell groups correspond to the N sub-fields in at least one of the following orders: an order of serving cell index and/or serving cell group index; an order determined according to an indication of the DCI; or an order of the number of bits required for channel resource allocation for each serving cell and/or serving cell group.

For details not elaborated in implementation II, reference may be made to the same or corresponding parts in implementation I, which will not be elaborated again herein.

### Implementation III

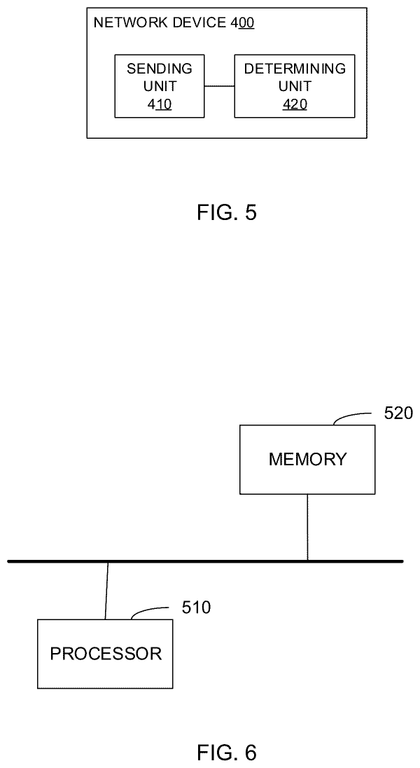

Referring to FIG. 5, FIG. 5 is a schematic structural diagram of a network device 400 provided in implementation III of the disclosure. The network device 400 is configured for resource indication. The network device 400 includes a sending unit 410. The sending unit 410 is configured for the network device to send DCI to a terminal device. The DCI is used for scheduling P channels, and the P channels are located on at most N serving cells and/or serving cell groups, where P and N each are a positive integer and N≤P. The DCI includes a resource assignment field, and the resource assignment field indicates resources for the P channels.

In an implementation, the resource assignment field includes N sub-fields. The N sub-fields are set in a descending order of the number of bits in each sub-field, and the terminal device does not expect that the number of bits required for channel resource allocation for an X^{th} serving cell and/or serving cell group is less than the number of bits required for channel resource allocation for an (X+1)^{th} serving cell and/or serving cell group, where X is a positive integer and 1≤X<N. Alternatively, the N sub-fields are set in an ascending order of the number of bits, and the terminal device does not expect that the number of bits required for channel resource allocation for an X^{th} serving cell and/or serving cell group is greater than the number of bits required for channel resource allocation for an (X+1)^{th} serving cell and/or serving cell group, where X is a positive integer and 1≤X<N.

In an implementation, if the number of bits required for channel resource allocation for each of R serving cells and/or serving cell groups in the N serving cells and/or serving cell groups is the same, the R serving cells and/or serving cell groups correspond to R sub-fields in the resource assignment field in an order of serving cell index and/or serving cell group index.

In an implementation, if the number of serving cells and/or serving cell groups on which the P channels are located is M and M<N, channels on the M serving cells and/or serving cell groups correspond to M consecutive sub-fields in the N sub-fields in a predefined order, and the number of bits in a sub-field other than the M sub-fields in the N sub-fields is a predefined value.

In an implementation, the number of bits in the N sub-fields in the resource assignment field is configured by a network or specified in a protocol.

In an implementation, the resource assignment field is shared by the P channels. The network device further includes a determining unit 420. The determining unit 420 is configured to obtain a second resource allocation granularity according to at least one of a second number of bits, a third number of bits, or a first resource allocation granularity, where the number of bits required for resource allocation for each of the P channels is a first number of bits, the second number of bits is a sum of all the first number of bits, and the third number of bits is the number of bits in the resource assignment field.

In an implementation, Q channels in the P channels are located on the same serving cell or serving cell group, where Q is a positive integer. The determining unit 420 is configured to obtain a second resource allocation granularity for the Q channels according to at least one of a fifth number of bits, a sixth number of bits, or a first resource allocation granularity, where the number of bits required for resource allocation for each of the Q channels is a fourth number of bits, the fifth number of bits is a sum of all the fourth number of bits, and the sixth number of bits is the number of bits in a sub-field corresponding to the Q channels in the resource assignment field.

In an implementation, the second number of bits is less than or equal to the third number of bits, or the fifth number of bits is less than or equal to the sixth number of bits. The determining unit 420 is further configured to: determine that the second resource allocation granularity is the same as the first resource allocation granularity; or determine the second resource allocation granularity based on the first resource allocation granularity and a first value; or determine that the second resource allocation granularity is a first candidate value in a first candidate value set, where the first candidate value is a minimum value among candidate values in the first candidate value set that are greater than or equal to a second value.

In an implementation, the second number of bits is greater than the third number of bits, or the fifth number of bits is greater than the sixth number of bits. The determining unit 420 is further configured to: determine the second resource allocation granularity according to the first resource allocation granularity and a first value; or determine that the second resource allocation granularity is a second candidate value in a second candidate value set, where the second candidate value is a minimum value among candidate values in the second candidate value set that are greater than or equal to a second value.

In an implementation, the determining unit is further configured to: determine the first value according to the second number of bits and the third number of bits, or determine the first value according to the fifth number of bits and the sixth number of bits; and/or determine the second value according to the first resource allocation granularity and the first value.

In an implementation, the first resource allocation granularity is one PRB or one group of PRBs, where the group of PRBs includes at least two PRBs.

In an implementation, the number of bits of the sub-field in the resource assignment field is configured by a network or specified in a protocol.

In an implementation, channels on one or more serving cells and/or serving cell groups in the N serving cells and/or serving cell groups correspond to the N sub-fields in at least one of the following orders: an order of serving cell index and/or serving cell group index; an order determined according to an indication of the DCI; or an order of the number of bits required for channel resource allocation for each serving cell and/or serving cell group.

If channels on multiple serving cells and/or serving cell groups are scheduled by single DCI, the DCI needs to include resource allocation indications for multiple channels, and there may be two indication modes: indication mode I, in which multiple channels each correspond to a separate indicator field; and indication mode II, in which multiple channels share the same indicator field. Indication mode I and indication mode II as well as examples thereof are the same as those described in implementation I of the disclosure. For details not elaborated in implementation III, reference can be made to the same or corresponding parts in implementation I, which will not be described again herein.

### Implementation IV

Referring to FIG. 6, FIG. 6 is a schematic structural diagram of a device 500 provided in implementation IV of the disclosure. The device may be a terminal device or a network device. The device 500 includes a processor 510 and a memory 520, where the processor 510 and the memory 520 are in communication connection with each other via a bus system.

The memory 520 is a computer-readable storage medium which stores programs executable by the processor 510. The processor 510 is configured to invoke the programs in the memory 510 to perform corresponding procedures in the method for resource indication implemented by the network device provided in implementation I, or perform corresponding procedures in the method for resource indication implemented by the terminal device provided in implementation I.

The processor 510 may be an independent component, or may be a general name of multiple processing components, for example, may be a central processing unit (CPU), or may also be an application specific integrated circuit (ASIC), or may be one or more integrated circuits configured to implement the foregoing method, such as at least one microprocessor (digital signal processor (DSP)), or at least one field programmable gate array (FPGA).

Those skilled in the art can appreciate that in one or more of the above examples, the functions described in implementations of the disclosure may be implemented by hardware, software, firmware, or any combination thereof. When implemented by software, the instructions may be implemented by a processor executing software instructions. The software instructions may be formed by corresponding software modules. The software module may be stored in a computer-readable storage medium. The computer-readable storage medium can be any computer accessible usable-medium or a data storage device such as a server, a data center, or the like which integrates one or more usable media. The usable medium can be a magnetic medium (such as a soft disk, a hard disk, or a magnetic tape), an optical medium (such as a digital video disk (DVD)), or a semiconductor medium (such as a solid state disk (SSD)), etc. The computer-readable storage medium includes, but is not limited to, a random access memory (RAM), a flash memory, a read only memory (ROM), an erasable programmable ROM (EPROM), an electrically EPROM (EEPROM), a register, a hard disk, a mobile hard disk, a compact disc (CD)-ROM, or any other form of storage medium known in the art. An exemplary storage medium is coupled to the processor, such that the processor can read information from the storage medium and write information to the storage medium. The storage medium can also be a component of the processor. The processor and the storage medium may be located in an ASIC. In addition, the ASIC can be located in an access network device, a target network device, or a core network device. The processor and the storage medium may also be present as discrete components in the access network device, the target network device, or the core network device. When implemented by software, all or some of the functions can be implemented in the form of a computer program product. The computer program product includes one or more computer instructions. When the computer instructions are applied and executed on a computer or chip, all or some of the operations or functions of the implementations of the disclosure are performed. The computer can be a general-purpose computer, a special-purpose computer, a computer network, or other programmable apparatuses. The computer instruction can be stored in the computer-readable storage medium, or transmitted from one computer-readable storage medium to another computer-readable storage medium. For example, the computer instruction can be transmitted from one website, computer, server, or data center to another website, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc.

The implementations described above illustrate the disclosure but do not limit the disclosure, and those skilled in the art can obtain many alternative examples within the scope of the claims. It should be appreciated by those skilled in the art that the disclosure is not limited to the exact construction described above and illustrated in the drawings, and that various changes, modifications, equivalent substitutions, improvements, etc. may be made without departing from the scope of the disclosure as defined in the appended claims. Therefore, any modifications and variations made in light of the concepts and principles of the disclosure shall fall within the scope of the disclosure as defined in the appended claims.

I/We claim:

1. A method for resource indication, comprising:
receiving, by a terminal device, downlink control information (DCI) sent by a network device;
wherein the DCI is used for scheduling P channels, the P channels are located on at most N serving cells and/or serving cell groups, P and N each are a positive integer, and N≤P, wherein the DCI comprises a resource assignment field, and the resource assignment field indicates resources for the P channels.

2. The method of claim 1, wherein the resource assignment field comprises N sub-fields.

3. The method of claim 1, wherein the resource assignment field is shared by the P channels.

4. The method of claim 3, further comprising:
obtaining a second resource allocation granularity according to at least one of a second number of bits, a third number of bits, or a first resource allocation granularity, wherein the number of bits required for resource allocation for each of the P channels is a first number of bits, the second number of bits is a sum of all the first number of bits, and the third number of bits is the number of bits in the resource assignment field.

5. The method of claim 2, wherein Q channels in the P channels are located on the same serving cell or serving cell group, wherein Q is a positive integer; and the method further comprises:
obtaining a second resource allocation granularity for the Q channels according to at least one of a fifth number of bits, a sixth number of bits, or a first resource allocation granularity, wherein the number of bits required for resource allocation for each of the Q channels is a fourth number of bits, the fifth number of bits is a sum of all the fourth number of bits, and the sixth number of bits is the number of bits in a sub-field corresponding to the Q channels in the resource assignment field.

6. The method of claim 4, wherein when the second number of bits is less than or equal to the third number of bits or the fifth number of bits is less than or equal to the sixth number of bits,
the second resource allocation granularity is the same as the first resource allocation granularity; or
the second resource allocation granularity is determined according to the first resource allocation granularity and a first value; or
the second resource allocation granularity is a first candidate value in a first candidate value set, wherein the first candidate value is a minimum value among candidate values in the first candidate value set that are greater than or equal to a second value.

7. The method of claim 5, wherein when the second number of bits is less than or equal to the third number of bits or the fifth number of bits is less than or equal to the sixth number of bits,
the second resource allocation granularity is the same as the first resource allocation granularity; or
the second resource allocation granularity is determined according to the first resource allocation granularity and a first value; or
the second resource allocation granularity is a first candidate value in a first candidate value set, wherein the first candidate value is a minimum value among candidate values in the first candidate value set that are greater than or equal to a second value.

8. The method of claim 4, wherein when the second number of bits is greater than the third number of bits or the fifth number of bits is greater than the sixth number of bits,
the second resource allocation granularity is determined according to the first resource allocation granularity and a first value; or
the second resource allocation granularity is a second candidate value in a second candidate value set, wherein the second candidate value is a minimum value among candidate values in the second candidate value set that are greater than or equal to a second value.

9. The method of claim 6, wherein:
the first value is determined according to the second number of bits and the third number of bits, or is determined according to the fifth number of bits and the sixth number of bits;
the second value is determined according to the first resource allocation granularity and the first value.

10. The method of claim 2, wherein channels on at least one serving cell and/or serving cell group in the N serving cells and/or serving cell groups correspond to the N sub-fields in at least one of the following orders:
an order of serving cell index and/or serving cell group index;
an order determined according to an indication of the DCI; or
an order of the number of bits required for channel resource allocation for each serving cell and/or serving cell group.

11. A terminal device, comprising:
a transceiver;
a memory; and
a processor configured to execute one or more programs stored in the memory to:
cause the transceiver to receive downlink control information (DCI) sent by a network device;
wherein the DCI is used for scheduling P channels, the P channels are located on at most N serving cells and/or serving cell groups, P and N each are a positive integer, and N≤P, wherein the DCI comprises a resource assignment field, and the resource assignment field indicates resources for the P channels.

12. The terminal device of claim 11, wherein the resource assignment field comprises N sub-fields.

13. The terminal device of claim 11, wherein the resource assignment field is shared by the P channels.

14. The terminal device of claim 13, wherein the processor is configured to:
obtain a second resource allocation granularity according to at least one of a second number of bits, a third number of bits, or a first resource allocation granularity, wherein the number of bits required for resource allocation for each of the P channels is a first number of bits, the second number of bits is a sum of all the first number of bits, and the third number of bits is the number of bits in the resource assignment field.

15. The terminal device of claim 12, wherein Q channels in the P channels are located on the same serving cell or serving cell group, wherein Q is a positive integer; and the processor is configured to:
obtain a second resource allocation granularity for the Q channels according to at least one of a fifth number of bits, a sixth number of bits, or a first resource allocation granularity, wherein the number of bits required for resource allocation for each of the Q channels is a fourth number of bits, the fifth number of bits is a sum of all the fourth number of bits, and the sixth number of bits is the number of bits in a sub-field corresponding to the Q channels in the resource assignment field.

16. The terminal device of claim 14, wherein the second number of bits is less than or equal to the third number of bits or the fifth number of bits is less than or equal to the sixth number of bits, and the processor is further configured to:
determine that the second resource allocation granularity is the same as the first resource allocation granularity; or
determine the second resource allocation granularity according to the first resource allocation granularity and a first value; or
determine that the second resource allocation granularity is a first candidate value in a first candidate value set, wherein the first candidate value is a minimum value of among candidate values in the first candidate value set that are greater than or equal to a second value.

17. The terminal device of claim 14, wherein the second number of bits is greater than the third number of bits or the fifth number of bits is greater than the sixth number of bits, and the processor is further configured to:
determine the second resource allocation granularity according to the first resource allocation granularity and a first value; or
determine that the second resource allocation granularity is a second candidate value in a second candidate value set, wherein the second candidate value is a minimum value among candidate values in the second candidate value set that are greater than or equal to a second value.

18. The terminal device of claim 16, wherein the calculating unit is further configured to:
determine the first value according to the second number of bits and the third number of bits, or determine the first value according to the fifth number of bits and the sixth number of bits; and/or
determine the second value according to the first resource allocation granularity and the first value.

19. The terminal device of claim 12, wherein channels on one or more serving cells and/or serving cell groups in the N serving cells and/or serving cell groups correspond to the N sub-fields in at least one of the following orders:
an order of serving cell index and/or serving cell group index;
an order determined according to an indication of the DCI; or
an order of the number of bits required for channel resource allocation for each serving cell and/or serving cell group.

20. A network device, comprising:
a transceiver;
a memory; and
a processor configured to execute one or more computer programs stored in the memory to: cause the transceiver to send downlink control information (DCI) to a terminal device;
wherein the DCI is used for scheduling P channels, the P channels are located on at most N serving cells and/or serving cell groups, P and N each are a positive integer, and N≤P, wherein the DCI comprises a resource assignment field, and the resource assignment field indicates resources for the P channels.
